(19) United States
(12) Patent Application Publication
(10) Pub. No.: US 2008/0134984 A1
(43) Pub. Date: Jun. 12, 2008

(54) CONTAINMENT CAGE LINERS FOR ANIMAL HUSBANDRY

(76) Inventors: Dee L. Conger, La Jolla, CA (US); Thomas M. Perazzo, San Diego, CA (US)

Correspondence Address: GRANT ANDERSON LLP;C/O PORTFOLIOIP, P.O. BOX 52050, MINNEAPOLIS, MN, 55402, US

(21) Appl. No.: 11/868,877

(22) Filed: Oct. 8, 2007

Related U.S. Application Data
(60) Provisional application No. 60/829,487, filed on Oct. 13, 2006.

(51) Int. Cl. A01K 1/03

(52) U.S. Cl. 119/417

(57) ABSTRACT

Provided are animal containment cage liners useful for improving cage cleanliness and extending the period of time between cage cleanings. Also provided are processes for using such liners.

### RELATED APPLICATIONS

This application claims priority from U.S. Provisional Patent Application No. 60/829,487, filed on 13 Oct. 2006, entitled “Containment Cage Liners for Animal Husbandry,” naming Dee Conger and Thomas Perazzo as inventors, and designated by attorney docket no. INO-1003-PV, which is incorporated by reference herein in its entirety.

### FIELD OF THE INVENTION

Described herein are animal containment cage liners useful for improving cage cleanliness and extending the period of time between cage cleanings. Also provided are methods for using such liners. Such systems and components are useful in animal husbandry, for example, such as for maintaining, breeding, observing and studying animals.

### BACKGROUND

Animal containment systems are utilized in a variety of applications, such as for animal transportation, breeding and maintenance. Animals contained in the systems often are laboratory animals such as rodents, and such animals often are contained in a vivarium. Containment systems often include animal cages in which the animals are housed and a rack unit onto which cages are mounted. Animals contained in such systems emit several gaseous and particulate contaminates that are health risks to housed animals and human personnel maintaining the systems. Accordingly, cages generally are designed for multiple use, which requires they are washed and sterilized about every week for two years or more in an animal containment facility, for example, especially in a facility practicing Good Laboratory Procedures (GLPs). Multiple-use cages generally have relatively thick walls and components often are constructed from resilient materials that can withstand multiple washes and sterilizations.

Due to these aspects of multiple-use animal containment systems, a significant portion of animal containment resources is not utilized to house animals. Instead, resources for washing and sterilizing multiple-use components represent a comparatively large fraction of the total resources required for animal containment. What has been needed are devices and methods that allow for the efficient containment of animals that may serve to decrease the amount of laboratory resources spent washing and sterilizing multiple-use cages.

### BRIEF DESCRIPTION OF THE DRAWINGS

The drawings illustrate embodiments of the invention.

FIG. 1 shows an exploded view of a rodent containment cage and cage liner assembly from the upper front perspective.

FIG. 2 shows an exploded view of a rodent containment cage and cage liner assembly from the upper front perspective, in which the liner comprises channels, aperture in the channels and walls shorter than the liner embodiment shown in FIG. 1. The containment cage shown in FIG. 2 includes an aperture through which an air introduction nozzle is inserted, and the cage liner wall fits below the nozzle.

FIG. 3 shows an exploded view of a rodent containment cage and cage liner assembly from the upper front perspective, in which the cage liner includes an aperture configured to receive a nozzle from the animal containment system.

FIG. 4 is a cross sectional view of the assembly embodiment shown in FIG. 3.

FIG. 5 is an enlarged view of a portion of the assembly of FIG. 4 indicated by the encircled portion 5-5 of FIG. 4.

### DETAILED DESCRIPTION

Provided herein are animal containment cage liners, which fit within an animal containment cage and separate and shield contained animals and/or bedding material from the inner walls of the containment cage. The liners are shaped such that a contained animal and/or bedding material may not contact a surface of the containment cage, or contacts the surface of the containment cage with less frequency than if a liner is not inserted into the cage. Containment cage liners often comprise relatively thin walls constructed from a polymer. Such liners often are disposed of after a single-use and frequently are constructed from a recyclable material. Features of cage liners described herein substantially reduce or prevent the possibility contained animals damage the relatively thin polymeric material (e.g., gnawing damage). Cage liners can enhance cage cleanliness and decrease the frequency of cage cleaning as the cage liner can be removed and replaced with another cage liner one or more times before the cage is cleansed. Cage liners described herein can be efficiently nested, thereby advantageously reducing required storage space.

Cage Liners

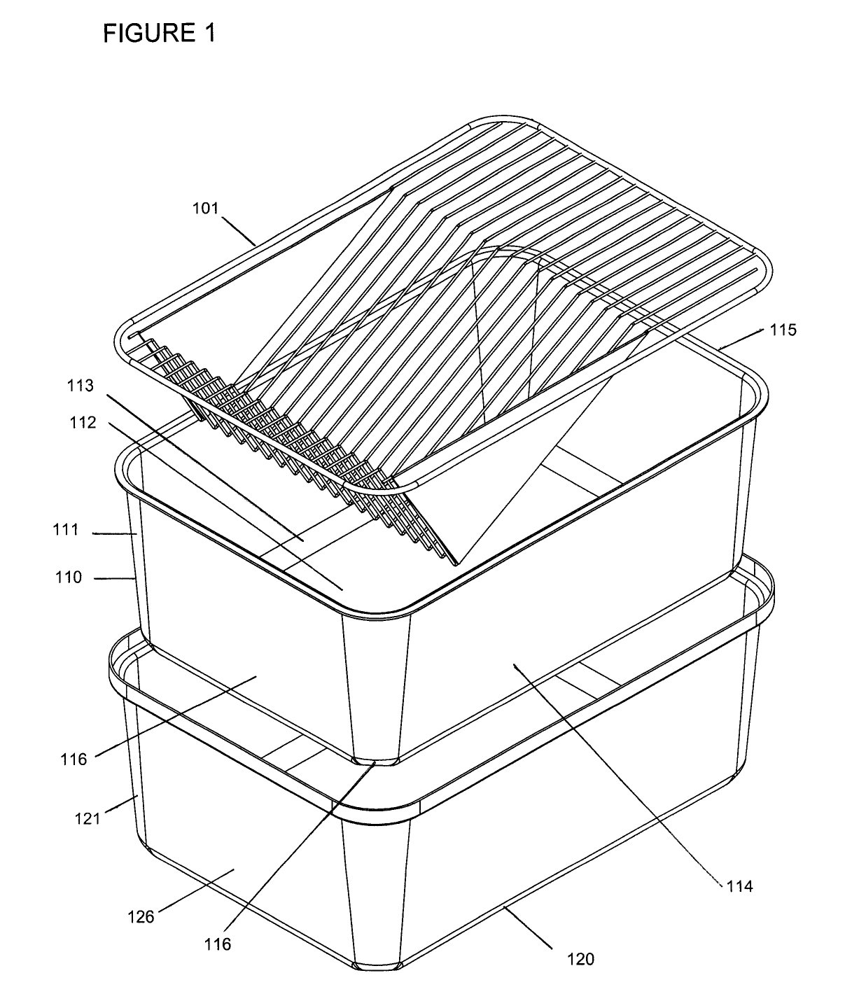

Animal cages often comprise a cage base member and a cover member. An animal cage base sometimes is provided separately from a cover, the cover often can be sealingly attached to the cage base and the cover often is readily detachable from the base. In some embodiments, the cover is constructed from a polymer and optionally comprises one or more apertures for receiving one or more components from an air supply/exhaust system (e.g., a tubular nozzle). In certain embodiments, a cover member is a wire bar lid, as shown in FIG. 1, and sometimes a cage includes a cage base, a wire bar lid and a polymer cover in attachment with the cage base. In embodiments described herein, the cage base is in contact with a cage liner. The cage liner typically contacts surfaces interior surfaces of the cage base. An animal may be placed in the cage base comprising the liner before a cover is contacted with the base.

A variety of animals can be contained within cages described herein. Rodents often are contained within such units, including but not limited to mice, rats, hamsters, gerbils, guinea pigs, chinchillas and rabbits. The animal can be transgenic, inbred, immunodeficient, lack one or more functional genes (e.g., knock-out animal), and/or can include one or more xenografts. Examples of immunodeficient mice include nude mice and severe combined immune deficiency (SCID) mice. Cells from cultured cell lines, cultured primary cells or directly from another animal or tissue (e.g., biopsy) may be utilized for xenografts (e.g., cancer cells from a human). The animals contained in cages and systems described herein can be utilized in a variety of manners, including but not limited to breeding, studying cancer and other diseases, assessing parameters of potential drugs (e.g., toxicity, efficacy, maximum tolerated doses, effective doses and other pharmacokinetic parameters), producing and isolating antibodies and producing and isolating cells useful for preparing hybridomas, for example.

Cage liners provided herein reduce or prevent contact of animals, animal emissions, and bedding material with the containment cage. Featured herein are rodent containment cage liners comprising a wall or walls and a bottom, where: the cage liner is constructed from a polymer, and the thickness of each wall is about 0.01 inches to about 0.08 inches. In some embodiments, the thickness of the bottom is about 0.01 inches to about 0.08 inches. In certain embodiments, the thickness of the wall(s) and/or bottom is about 0.02 inches to about 0.06 inches, or about 0.02 inches to about 0.03 inches.

A cage liner is manufactured from any material suitable for housing an animal, such as a small rodent, for a time period of about one week or greater. The material may be rigid, and often is a semi-rigid or flexible material. The cage base sometimes is constructed entirely, or in part, from a translucent or transparent material. Examples of materials utilized for manufacture of a cage liner include, but are not limited to, thermoplastics, polyesters, polypropylene (PP), high-density polyethylene, low-density polyethylene, polyethylene teraphthalate (PET), polyvinyl chloride (PVC), polyethylenefluoroethylene (PEFE), polystyrene (PS), high-density polystryrene, acrylnitrile butadiene styrene copolymers and the like. In certain embodiments, a cage is constructed from PET or PS (e.g., high density PS). The material sometimes is selected for the intended use of the liners, such as single-use liners, disposable liners, recyclable liners and crushable liners, for example. Sidewall members and bottom members are of any thickness for substantially maintaining cage liner integrity for about one, two, three or four or more weeks of animal containment, and the thickness sometimes is about 0.01 inches to about 0.08 inches. The sidewalls often are of substantially uniform thickness. A cage liner often is manufactured as a single unit and by any convenient process, sometimes in an injection molding, thermoforming or vacuum forming process, for example. A cage liner often is packaged for shipment, sometimes as a single unit and sometimes with other like units (e.g., as a nested set described hereafter). A cage liner sometimes is washed and/or sterilized (e.g., U.V. irradiation, gamma irradiation) prior to packaging. Cage bases can be packaged in any material, including but not limited to materials containing polystyrene, polyvinyl chloride, low-density polyethylene and the like.

Each edge junction or corner junction of a wall or walls and/or the bottom in the liners has a geometry convenient for manufacture and use, such as a sharp edge, smooth edge or rounded edge. It has been determined that certain corner and edge geometries in animal containment components advantageously reduce or abrogate the possibility of damage caused by animal residents (e.g., gnawing damage by rodents). This resistance to damage caused by contained animals is especially applicable to single-use containment components having thin polymer walls (e.g., about 0.01 inches to about 0.08 inches). Damage resistant edge and corner orientations have been determined based upon a combination of (i) angle of edge or corner surfaces (in degrees) and (ii) edge or corner radius (in inches). The angle alpha between two surfaces is measured from the side of the surfaces on which an animal resides. When alpha is less than 180 degrees, the edge or corner minimum radius may be zero. When alpha is between 180 degrees and 360 degrees, a minimum radius can be determined by the following equation:

minimum radius=0.25/(tan((pi/360)(360−alpha))).

For example, minimum edge and corner radii of 0.02, 0.04, 0.07, 0.09, 0.12, 0.14, 0.18, 0.21, 0.25, 0.30, 0.36, 0.43, 0.54, 0.69, 0.93, 1.42, 2.86 and 5.73 inches often are incorporated when the corresponding angle alpha is 190, 200, 210, 220, 230, 240, 250, 260, 270, 280, 290, 300, 310, 320, 330, 340, 350 and 355 degrees, respectively, in accordance with this relation. Thus, provided are edge and corner angle/minimum radius combinations in accordance with the above relation. One or more wall junctions and corners often are rounded junctions and rounded corners in the liners. The rounded junctions and rounded corners sometimes are defined by a radius of about 0.25 inches or greater, and sometimes the radius is about 0.30 inches or greater.

In particular embodiments, one or more junctions between the bottom and two walls comprise two or more corners, and sometimes one or more of the junctions comprises three corners. Multiple corners in each junction improves crumple resistance to impact. Crumple resistance to impact provides benefits of maintaining nesting efficiency, reducing potential damage caused by animal gnawing (e.g., impact can crumple a corner and introduce a sharp edge on which an animal may gnaw), and maintaining cage integrity upon impact (e.g., not exposing the cage interior to the outside environment). In certain embodiments, a corner is effectively split into 10, 9, 8, 7, 6, 5, 4 3 or 2 corners, each often defined by a radius.

A cage liner is of any geometry suitable for housing animals, such as cylindrical, substantially cylindrical, conical, rectangular, square, cubic, rhomboid and the like, for example. A cage base often comprises a bottom member that supports a plurality of sidewall members (e.g., four sidewall members). One sidewall member often is referred to as the “front sidewall member” and the opposite sidewall member often is referred to as the “rear sidewall member.” Opposing sidewall members sometimes are parallel, substantially parallel, not parallel, rhomboid, substantially rhomboid or a combination thereof. In some embodiments, opposing sidewalls are not parallel, and are not vertical with respect to the bottom. In such embodiments, a sidewall, and sometimes all sidewalls, are at a non-90 degree angle with respect to the bottom, such as an angle between about 91 degrees and about 105 degrees, an angle of about 92 degrees to about 98 degrees or an angle of about 95 degrees, for example. Such angled sidewall configurations (with respect to the bottom) can promote cage base nesting (described in greater detail hereafter). In some embodiments, at least one set of opposing walls taper inwards towards the cage liner bottom, and sometimes all walls taper inwards towards the bottom.

In some embodiments, a cage liner comprises one or more apertures. One or more apertures may be located in one or more cage liner walls and/or in a cage liner bottom. The aperture is of any suitable size and orientation for containing animals. An aperture may be relatively small (e.g., about 0.06 inches to about 0.12 inches in diameter), and can allow air between the cage and the liner to escape as the liner is inserted into the cage, and/or receive a tool for removing the liner from the cage (e.g., a hook tool inserted into the hole can facilitate liner removal and replacement), for example. An aperture may be relatively large (e.g., about 2 inches in diameter), and can accommodate a cage insertion member from a containment system, such as tube that delivers or exhausts air to or from the cage or delivers water to the cage, for example.

In certain embodiments, a cage liner comprises one or more channels. One or more channels may be located in one or more cage liner walls and/or in a cage liner bottom. A channel may or may not intersect with another channel in a liner, and a channel may be parallel to another channel, for example. A channel may extend to a wall/bottom and/or wall/wall junction in a liner, and may extend to a wall edge, such as a top edge of a wall. A channel also can terminate within a wall and/or bottom, and not extend to a wall/bottom junction, wall/wall junction or wall edge. In certain embodiments, one or more channels are located in a cage liner wall and extend from the bottom of the wall to the top edge of the wall, and sometimes one or more of the channels are located in a cage liner wall and extend from the bottom to a portion of the wall lower than the top edge of the wall. In some embodiments, one or more channels in a liner comprises one or more apertures. A channel can allow air between a liner and a cage to escape as the liner is inserted into the cage. Air may escape from the terminal portion of a channel that extends to the top edge of a liner wall, and can escape from an aperture in a channel that terminates within a liner wall length. For channels that extend to the edge of a wall, a depression formed by the channel can serve as a surface that can be gripped to facilitate removal of the liner from the cage. For channels that terminate within the length of a wall, an aperture in the channel can serve as a contact point for a tool that facilitates removal of the liner from the cage (e.g., a wire hook tool). The surface of a channel often extends into the interior of the liner. The cross section of a channel is of any geometry that allows for the functions described above, and is resistant to damage that may be caused by a contained animal (e.g., gnawing damage by a rodent). For example, a channel often has a semi-circle or semi-oval cross section, which forms an open groove on the outside surface of the liner and a convex structure on the interior surface of the liner. Such channels having semi-circle or semi-oval cross sections sometimes have a cross sectional radius of 0.25 inches or greater to prevent or lessen potential damage caused by contained animals.

The top edge of one or more sidewall members of a cage liner sometimes is contiguous with a flange portion that extends, often vertically, from the outer surface of the sidewall member. The flange sometimes forms a continuous surface around the top perimeter of the cage and its surface often is horizontal when the cage rests on its bottom member. The flange can be any width, sometimes about 0.03 inches to about 1 inch. The flange can increase cage liner rigidity and sometimes is configured to mate with a portion of a cover member, described further herein. In some embodiments, the flange includes an optional downward extending lip member, which sometimes mates with a corresponding member of a cover to form a detachable seal. The profile of the lip member of the liner is of any shape to allow a fit with a corresponding structure on the cover, where the profile sometimes is curved, and sometimes is S-shaped, V-shaped or J-shaped. The lip member and/or flange member of the cage liner sometimes are shaped to deflect when mated with a cover member to form a seal between the cage liner and the cover. The seal between the cage liner and the cover is of any convenient or useful type, including but not limited to an adhesive seal, compression fit, snap fit or interference fit, for example.

A cage liner sometimes comprises one or more indents in a sidewall member that extends towards the interior of the cage liner. One, two, three, four or more sidewalls sometimes include one or more indents, which can increase sidewall rigidity. Sidewall integrity enhancement can provide an advantage of increasing impact resistance to crumpling, advantages of which are described above. The depressed surface area of an indent can be trapezoidal or rectangular. The depressed distance of the indent vertical from a sidewall from which the indent extends often is continuous from the top of the indent to the bottom (e.g., the face is parallel to the side wall from which the indent is extended), and may be greater at the top of the indent, sometimes tapering from the top portion of the indent to the bottom portion. Such configurations allow for nesting of cage liners when they are not housing an animal, as described hereafter. An indent often is located in close proximity to a baffle or feeding structure integrated with or in association with a cover member (described in greater detail hereafter), thereby reducing airflow along sidewalls of the cage liner and increasing airflow parallel to and nearer to the cage bottom. An indent sometimes is configured to orient one or more optional cage insert members described hereafter (e.g., feeding tray), and sometimes it or a portion thereof is referred to as a “mount,” “cradle” or “support member” when utilized in this manner. A mount is of any geometry useful for supporting and orienting a cage insert member, and sometimes is an extension comprising a planar upper surface parallel with a liner unit bottom surface. In some embodiments, a mount or support member sometimes is formed by a wall of a cage liner and a depression in the indent, and is of a shape adapted to receive a cage insert. The horizontal end of each indent or mount sometimes is equidistant to an adjacent sidewall in some embodiments, and its horizontal midpoint thereby is located at the midpoint of the sidewall with which it is integrated. A cage liner bottom also may include one or more indents, which also can increase rigidity and crumple resistance.

A cage liner may include one or more mounts located on an outside surface of a sidewall member or bottom member, which sometimes are referred to herein as “outer support members” or “outer guide members,” which allow for convenient mounting of the liner into the cage. The outer support members or outer guide members are of any configuration allowing for mounting of the liner, and sometimes mate with or are supported by corresponding members in the cage. In some embodiments, a flange member contiguous with the top of one or more sidewall members serves as a guide member and/or support member. In certain embodiments, a guide member and/or support member is a flange, projection, rib or groove located on the exterior surface of a bottom member and/or one or both cage sidewall members (e.g., sidewall member adjacent to the front sidewall and rear sidewall).

A cage liner may be provided with another structure useful for containing animals. Any structure may be provided, such as bedding material, a shelter structure and/or a feeding structure (e.g., a polymer feeding tray, described in PCT/US2005/044977 filed on Dec. 13, 2005 (WO 2006/065773) or PCT/US2006/023038 filed on Jun. 13, 2006, each entitled “Containment Systems and Components For Animal Husbandry”). A cage liner also may be provided with one or more animals.

Nested Sets of Cage Liners

Cage liners can be inserted into one another like cage and several liners can be stacked, which is referred to herein as “nesting.” Nesting liners significantly reduces the volume of multiple liners, which is advantageous for shipping, storage before housing an animal, and storage after housing an animal, for example. Any convenient number of liners can be nested, including, but not limited to, 10 or more, 20 or more, 30 or more, 40 or more, 50 or more, 60 or more, 70 or more, 80 or more, 90 or more or 100 or more liners. The degree or efficiency of nesting sometimes can be expressed in terms of a percentage, which is the height or volume of the nested component within another like component containing it, relative to the overall height or volume of the nested component. Thus, the term “80% nested” indicates 80% of the volume or height of a nested cage member, for example, is contained within the member in which it is inserted. When stacked, cage liners provided herein often are 75% or more nested, sometimes 80% or more or 85% or more nested, and sometimes about 90% to about 95% nested. Such nesting calculations often are performed when no other components are in the liner (e.g., no bedding material).

A cage liner sometimes comprises a nesting separation member that facilitates separation of nested liners or substantially reduces or prevents compression of them. Compression or over-nesting of liners can lead to nested liners adhering to one another and interfere with freely separating nested units from one another. In certain embodiments, the nesting separation member is a curved member or indent member located at or near a flange member, for example. In some embodiments, a liner sometimes comprises an indent or boss that butts (e.g., interferes with) a corresponding indent or boss of an adjacent nested cage base. Edges and/or corners of such bosses or indents sometimes are defined by a radius of 0.03 inches or less. Such an indent or boss can facilitate separation of the nested liners from one another, and can prevent or substantially reduce compression and sticking of the nested liners to one another.

Cage Liner Covers

A cage liner described herein may be contacted with a lid or cover. The cover may be shaped to sealingly attach, often a reversible attachment, to the liner. The cover can be constructed from a polymer having a thickness of about 0.01 inches to about 0.08 inches, and the polymer may be the same or different from the polymer from which the liner is constructed. The thickness of the cover in some embodiments is about 0.02 inches to about 0.06 inches or about 0.02 inches to about 0.03 inches. The cover may be ventilated, and ventilation may be under static conditions or by positive air pressure, negative air pressure or a combination of positive air pressure and negative air pressure. A cover may contain one or more apertures, bosses, indents, channels, connectors, filters and/or filter shields, and can include cover features described in PCT/US2005/044977 or PCT/US2006/023038, supra.

Rodent Containment Cages with Inserted Cage Liners

In certain embodiments provided is a rodent containment cage base comprising a wall or walls and a bottom in combination with a liner described herein. A cage base often is a re-useable cage base, such a base constructed from a durable polymer (e.g., polycarbonate) and about 0.1 inches or greater in thickness. The liner sometimes is nested in the cage, and one or more wall surfaces of the rodent containment cage base often are in substantial contact with wall surfaces of the liner. In some embodiments, one or more surfaces of the bottom of the rodent containment cage is in substantial contact with one or more surfaces of the bottom of the liner. The term “substantial contact” or “effective contact” as used herein refers to a fit between a liner and a cage by which a substantial portion of each exterior surface of the liner is in direct contact with (i.e., mated with), or about 0.01 inches or less from, the corresponding interior surface of the cage.

A cage base containing a liner may be in contact with other containment system components. For example, the cage base may be in contact with a wire bar lid, a polymeric lid (e.g., a lid comprising sidewalls and one or more apertures in the sidewalls, a watering device and/or one or more air injection or air exhaust nozzles. The liner may be in contact with one or more of these components. For example, an aperture in a liner wall may be shaped to receive (e.g., sealingly receive) an air injection nozzle that inserts through a sidewall of the cage base, and the top edge of a liner may contact a wire bar lid or other cover of the cage. A liner may have walls shorter, higher or about the same height as walls of the cage base.

A cage liner can be removed from a cage by any suitable method. Removal of the liner may be automated (e.g., by a robot or automated device) or non-automated (e.g., by hand or by using a tool). A liner may be removed by engaging a flange or channel coextensive with the top edge of a wall of the liner, or engaging an aperture in the liner. A cage base comprising a liner can be utilized in conjunction with a rack that receives multiple cages, a watering system, an air delivery system (e.g., blower), an air exhaust system (e.g., heating, ventilating and air-conditioning (HVAC) system), temperature regulation, lighting and/or sensor system, for example.

Processes for Utilizing Rodent Containment Cage Liners

Provided are processes for containing a rodent in a rodent containment cage that employ a liner, and methods for replacing a liner in a rodent containment cage. For example, a representative process can comprise: (a) inserting a cage liner described herein in a rodent containment cage, and (b) placing a rodent in the cage. Some processes include removing the cage liner from the rodent containment cage and inserting another cage liner, and some processes can include removing the cage liner from the rodent containment cage, disposing of the cage liner and inserting another cage liner. In these processes, removing a cage liner and inserting another cage liner is repeated one or more times (e.g., 2, 3, 4, 5, 6, 7, 8, 9 or 10 or more times). A cage liner may include one or more components when it is inserted into a cage base, such as bedding material, one or more animals, a polymeric feed tray and/or an animal shelter structure, for example.

### EXAMPLES OF CAGE LINER EMBODIMENTS

FIGS. 1, 2, 3 and 4 illustrate examples of cage liner embodiments and are not limiting. FIG. 1 shows an exploded view of a rodent containment cage and cage liner assembly from the upper front perspective. Wire bar cover (101) can engage cage liner (110) when the latter is inserted in cage base (120). Cage liner (110) includes sides (114), a bottom (112), rounded wall/wall junctions (111), rounded wall/bottom junctions (113), and a flange (115) coextensive with the top edges of the walls. The surfaces of the cage liner formed by these elements substantially contact corresponding interior surfaces of the cage base. Each junction between two walls and the bottom in the liner comprises multiple corners, which enhances impact resistance of the liner.

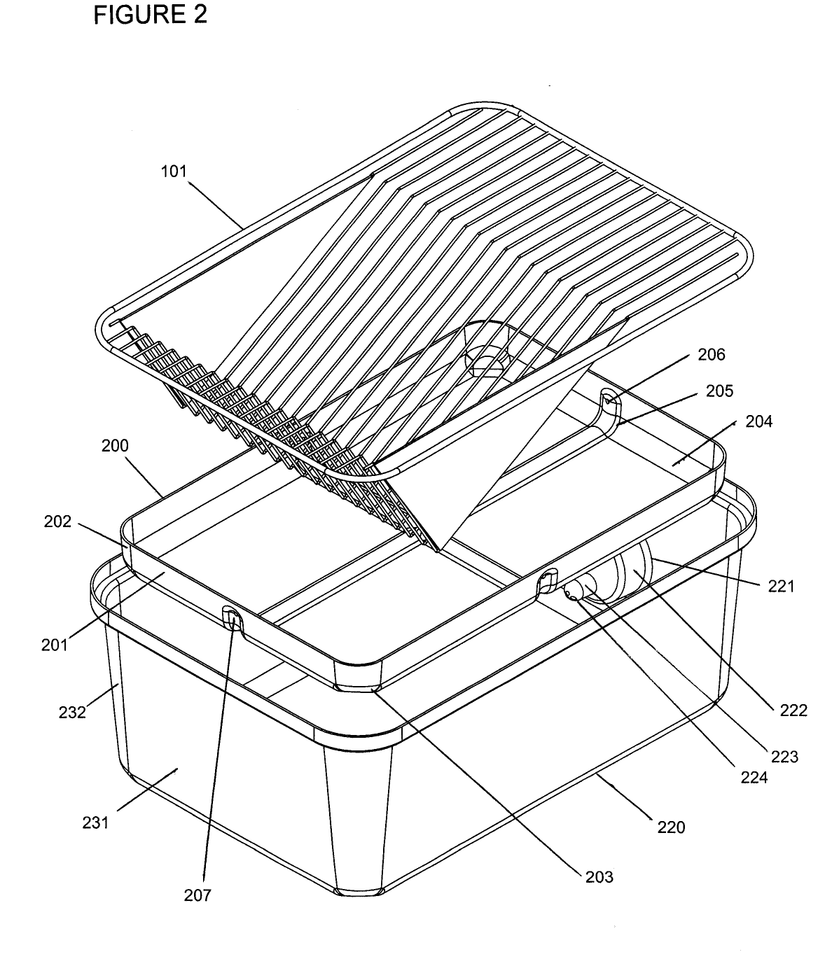

FIG. 2 shows an exploded view of a rodent containment cage (220) and cage liner (200) assembly from the upper front perspective. The liner comprises channels (205), apertures in the channels (206) and walls shorter than the liner embodiment shown in FIG. 1. Like the liner in FIG. 1, the liner includes rounded wall/wall junctions (202), rounded wall/bottom junctions (204), and junctions between two walls and the bottom having multiple corners (203). An exterior surface of a channel (207) in the liner is shown where it terminates within the liner wall height and not at the top edge of the liner wall. Apertures (206) are placed near the channel termini and expel air between the cage base and the cage insert as the latter member is placed in the former member. The containment cage base (220) shown in FIG. 2 includes an aperture (221) through which an air introduction nozzle having larger diameter surface (222) and small diameter surface (223) is inserted, and the cage liner wall fits below the nozzle. The nozzle includes apertures (224) through which air is introduced into bedding placed in the cage insert.

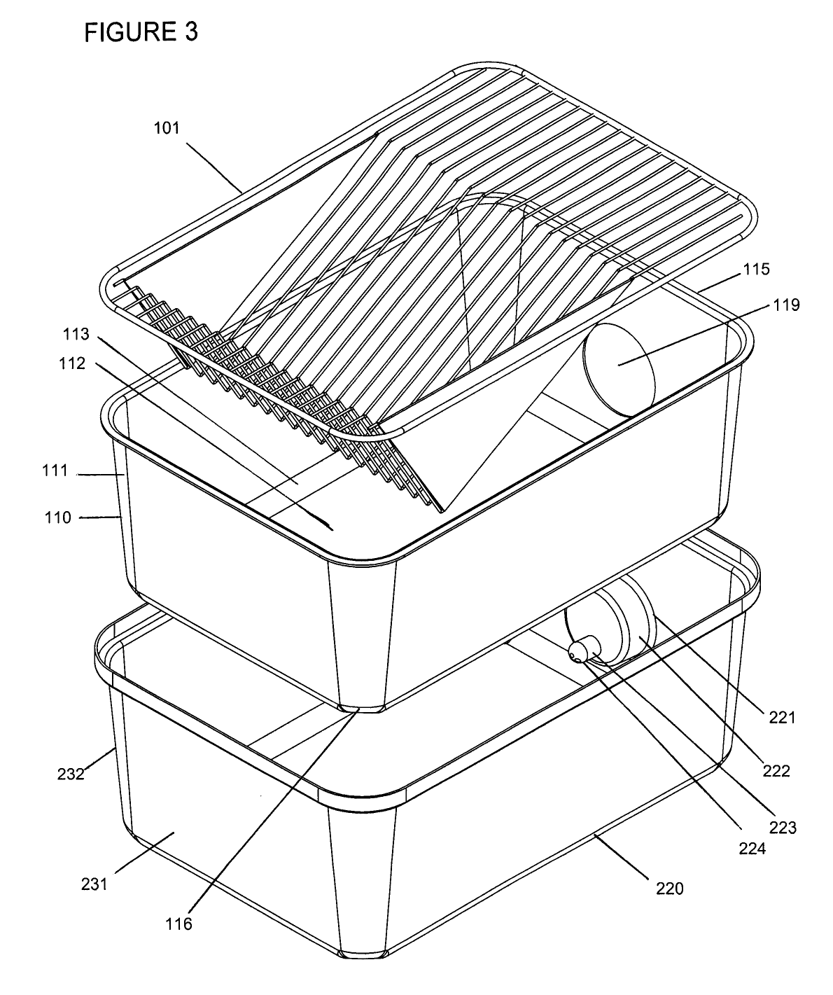

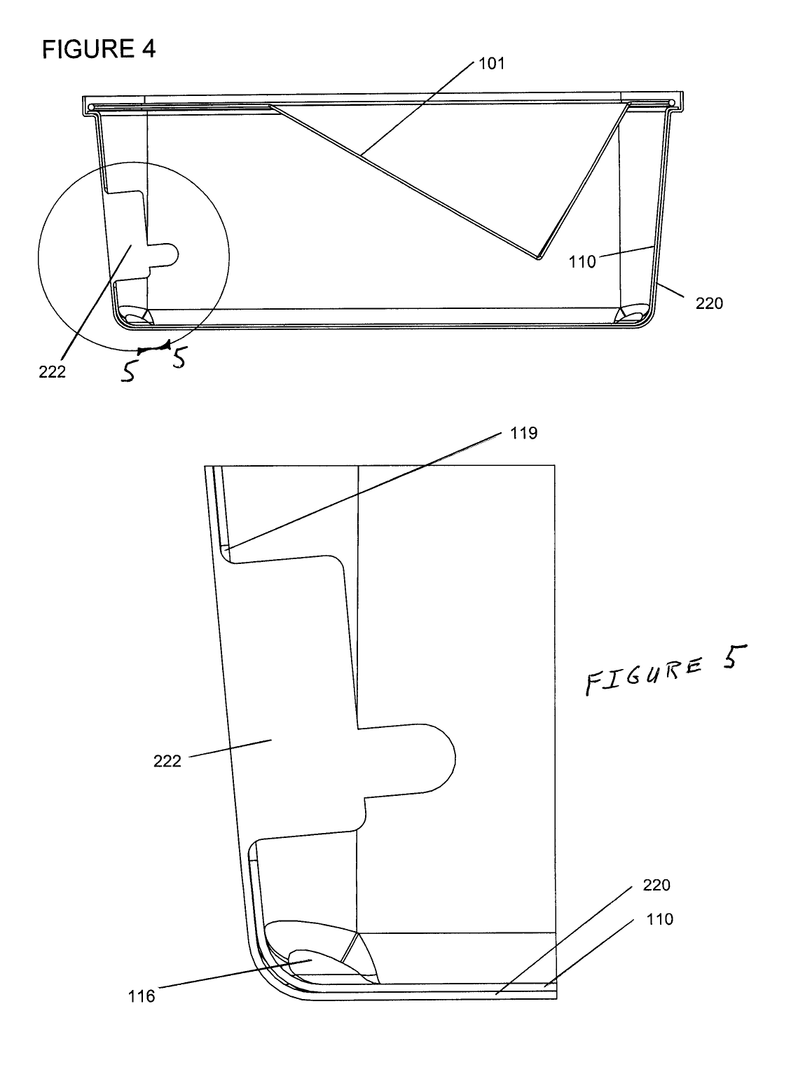

FIG. 3 shows an exploded view of a rodent containment cage base (220) and cage liner (110) assembly from the upper front perspective, in which the cage liner includes an aperture (119) configured to receive an air supply nozzle (having larger diameter surface (222) and small diameter surface (223)) from the animal containment system. Such a configuration allows for insertion of the air supply nozzle with minimal exposure of cage base surfaces to contained animals, animal emissions and other components such as bedding material. FIG. 4 is a cross sectional view of the assembly embodiment shown in FIG. 3, and shows the cage liner (110) is in substantial contact with the cage base (220).

The following embodiments are provided to illustrate certain aspects of the invention and are not limiting.

1. A rodent containment cage liner comprising a wall or walls and a bottom, wherein:
the cage liner is constructed from a polymer, and
the thickness of each wall is about 0.01 inches to about 0.08 inches.

2. The rodent containment cage liner of embodiment 1, wherein the thickness of the bottom is about 0.01 inches to about 0.08 inches.

3. The rodent containment cage liner of embodiment 1 or 2, wherein the thickness is about 0.02 inches to about 0.06 inches.

4. The rodent containment cage liner of any one of the preceding embodiments, wherein the thickness is about 0.02 inches to about 0.03 inches.

5. The rodent containment cage liner of any one of the preceding embodiments, wherein one or more wall junctions and corners are rounded junctions and rounded corners.

6. The rodent containment cage liner of any one of the preceding embodiments, wherein the rounded junctions and rounded corners are defined by a radius of about 0.25 inches or greater.

7. The rodent containment cage liner of embodiment 6, wherein the radius is about 0.30 inches or greater.

8. The rodent containment cage liner of any one of the preceding embodiments, wherein one or more junctions between the bottom and two walls comprise two or more corners.

9. The rodent containment cage liner of embodiment 8, wherein the one or more junctions comprise three corners.

10. The rodent containment cage liner of any one of the preceding embodiments, wherein the polymer is selected from the group consisting of polypropylene, high-density polyethylene, low-density polyethylene, polyethylene teraphthalate, polyvinyl chloride, polystyrene, high-impact polystyrene, polyethylenefluoroethylene, acrylnitrile butadiene styrene copolymers.

11. The rodent containment cage liner of any one of the preceding embodiments, wherein at least one set of opposing walls taper inwards towards the cage liner bottom.

12. The rodent containment cage liner of embodiment 11, wherein all walls taper inwards towards the bottom.

13. The rodent containment cage liner of any one of the preceding embodiments, wherein the cage liner is a single-use cage liner.

14. The rodent containment cage liner of any one of the preceding embodiments, which comprises one or more apertures.

15. The rodent containment cage liner of embodiment 14, wherein one or more of the apertures are located in a cage liner wall.

16. The rodent containment cage liner of embodiment 14, wherein one or more of the apertures are located in the cage liner bottom.

17. The rodent containment cage liner of any one of the preceding embodiments, which comprises one or more channels.

18. The rodent containment cage liner of embodiment 17, wherein one or more of the channels are located in a cage liner wall.

19. The rodent containment cage liner of embodiment 17, wherein one or more of the channels are located in the cage liner bottom.

20. The rodent containment cage liner of embodiment 17, wherein one or more of the channels are located in a cage liner wall and extend from the bottom to the top edge of the wall.

21. The rodent containment cage liner of embodiment 17, wherein one or more of the channels are located in a cage liner wall and extend from the bottom to a portion of the wall lower than the top edge of the wall.

22. The rodent containment cage liner of any one of embodiments 17-21, wherein one or more of the channels comprises an aperture.

23. A rodent containment cage comprising a wall or walls and a bottom in combination with a liner of any one of embodiments 1-22.

24. The rodent containment cage of embodiment 23, wherein the liner is nested in the cage.

25. The rodent containment cage of embodiment 24, wherein wall surfaces of the rodent containment cage are in substantial contact with wall surfaces of the liner.

26. The rodent containment cage of embodiment 24, wherein a surface of the bottom of the rodent containment cage is in substantial contact with a surface of the bottom of the liner.

27. A nested set of rodent containment cage liners of any one of embodiments 1-22, wherein the cage liners are about 75% nested or more.

28. The nested set of rodent containment cage liners of embodiment 28, wherein the cage liners are about 80% nested or more.

29. The nested set of rodent containment cage liners of embodiment 28, wherein the cage liners are about 85% nested or more.

30. The nested set of rodent containment cage liners of embodiment 28, wherein the cage liners are about 90% to about 95% nested.

31. The nested set of rodent containment cage liners of embodiment 28, wherein the each cage liner comprises an indent or boss that butts a corresponding indent or boss of an adjacent nested cage liner.

32. The nested set of rodent containment cage liners of embodiment 28, wherein the indent or boss facilitates separation of the nested cage unit liners from one another.

33. The nested set of rodent containment cage liners of embodiment 32, wherein the edges or corners of the boss or indent are defined by a radius of 0.03 inches or less.

34. The rodent containment cage liner of any one of embodiments 1-22, which is in sealing connection with a cover constructed from a polymer having a thickness of about 0.01 inches to about 0.08 inches.

35. The rodent containment cage liner of embodiment 34, wherein the thickness of the cover is about 0.02 inches to about 0.06 inches.

36. The rodent containment cage liner of embodiment 34, wherein the thickness of the cover is about 0.02 inches to about 0.03 inches.

37. The rodent containment cage liner of any one of embodiments 34-37, which is ventilated.

38. The rodent containment cage liner of embodiment 37, wherein the cage liner is ventilated by positive air pressure.

39. The rodent containment cage liner of embodiment 37, wherein the cage liner is ventilated by negative air pressure.

40. The rodent containment cage liner of embodiment 37, wherein the cage liner is ventilated by positive air pressure and negative air pressure.

41. A process for containing a rodent in a rodent containment cage, which comprises: (a) inserting a cage liner of any one of embodiments 1-22 in a rodent containment cage, and (b) placing a rodent in the cage.

42. The process of embodiment 41, which comprises removing the cage liner from the rodent containment cage and inserting another cage liner.

43. The process of embodiment 41, which comprises removing the cage liner from the rodent containment cage, disposing of the cage liner and inserting another cage liner.

44. The process of embodiment 42, wherein removing the cage liner and inserting another cage liner is repeated one or more times.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, yet these modifications and improvements are within the scope and spirit of the invention.

The invention illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the invention claimed. The term “a” or “an” can refer to one of or a plurality of the elements it modifies (e.g., “a cage” can mean one or more cages) unless it is contextually clear either one of the elements or more than one of the elements is described. The term “about” as used herein refers to a value sometimes within 10% of the underlying parameter (i.e., plus or minus 10%), a value sometimes within 5% of the underlying parameter (i.e., plus or minus 5%), a value sometimes within 2.5% of the underlying parameter (i.e., plus or minus 2.5%), or a value sometimes within 1% of the underlying parameter (i.e., plus or minus 1%), and sometimes refers to the parameter with no variation. For example, a weight of “about 100 grams” can include weights between 90 grams and 110 grams. Thus, it should be understood that although the present invention has been specifically disclosed by representative embodiments and optional features, modification and variation of the concepts herein disclosed may be resorted to by those skilled in the art, and such modifications and variations are considered within the scope of this invention.

What is claimed is:

1. A rodent containment cage liner comprising a wall or walls and a bottom, wherein:
the cage liner is constructed from a polymer, and
the thickness of each wall is about 0.01 inches to about 0.08 inches.

2. The rodent containment cage liner of claim 1, wherein the thickness of the bottom is about 0.01 inches to about 0.08 inches.

3. The rodent containment cage liner of claim 2, wherein the thickness is about 0.02 inches to about 0.06 inches.

4. The rodent containment cage liner of claim 1, wherein one or more wall junctions and corners are rounded junctions and rounded corners.

5. The rodent containment cage liner of claim 4, wherein the rounded junctions and rounded corners are defined by a radius of about 0.25 inches or greater.

6. The rodent containment cage liner of claim 1, wherein the polymer is selected from the group consisting of polypropylene, high-density polyethylene, low-density polyethylene, polyethylene teraphthalate, polyvinyl chloride, polystyrene, high-impact polystyrene, polyethylenefluoroethylene, acrylnitrile butadiene styrene copolymers.

7. The rodent containment cage liner of claim 1, wherein at least one set of opposing walls taper inwards towards the cage liner bottom.

8. The rodent containment cage liner of claim 7, wherein all walls taper inwards towards the bottom.

9. The rodent containment cage liner of claim 1, which comprises one or more apertures.

10. The rodent containment cage liner of claim 1, which comprises one or more channels.

11. The rodent containment cage liner of claim 10, wherein one or more of the channels are located in a cage liner wall and extend from the bottom to a portion of the wall lower than the top edge of the wall.

12. The rodent containment cage liner of claim 10, wherein one or more of the channels comprises an aperture.

13. A rodent containment cage comprising a wall or walls and a bottom in combination with a liner comprising a wall or walls and a bottom, wherein:
the cage liner is constructed from a polymer, and
the thickness of each wall is about 0.01 inches to about 0.08 inches.

14. The rodent containment cage of claim 13, wherein the liner is nested in the cage.

15. The rodent containment cage of claim 14, wherein wall surfaces of the rodent containment cage are in substantial contact with wall surfaces of the liner.

16. The rodent containment cage of claim 14, wherein a surface of the bottom of the rodent containment cage is in substantial contact with a surface of the bottom of the liner.

17. A nested set of rodent containment cage liners of claim 13, wherein the cage liners are about 75% nested or more.

18. The nested set of rodent containment cage liners of claim 17, wherein the indent or boss facilitates separation of the nested cage unit liners from one another.

19. The rodent containment cage liner of claim 13, wherein the cage liner is ventilated.

20. A process for containing a rodent in a rodent containment cage, which comprises:
(a) inserting a cage liner comprising a wall or walls and a bottom, wherein:
the cage liner is constructed from a polymer, and
the thickness of each wall is about 0.01 inches to about 0.08 inches; and
(b) placing a rodent in the cage.

21. The process of claim 20, which further comprises removing the cage liner from the rodent containment cage and inserting another cage liner.

22. The process of claim 20, which further comprises removing the cage liner from the rodent containment cage, disposing of the cage liner and inserting another cage liner.

23. The process of claim 21, wherein removing the cage liner and inserting another cage liner is repeated one or more times.

24. A rodent containment cage comprising a wall or walls and a bottom in combination with a cage liner, wherein:
the cage liner is constructed from a polymer,
the thickness of each wall is about 0.01 inches to about 0.08 inches, and
the cage liner comprises one or more channels.
